(19) United States
(12) Patent Application Publication
(10) Pub. No.: US 2017/0235355 A1
(43) Pub. Date: Aug. 17, 2017

(54) LAPTOP COMPONENT POWER CONSUMPTION SETTINGS RESPONSIVE TO MULTIPLE LID ANGLES

(71) Applicant: Lenovo Enterprise Solutions (Singapore) Pte. Ltd., Singapore (SG)

(72) Inventors: Shareef F. Alshinnawi, Apex, NC (US); Gary D. Cudak, Wake Forest, NC (US); J. Mark Weber, Wake Forest, NC (US); Joseph F. Herman, Raleigh, NC (US)

(21) Appl. No.: 15/046,080

(22) Filed: Feb. 17, 2016

(51) Int. Cl. G06F 1/32

(52) U.S. Cl. CPC G06F 1/3206; G06F 1/3234

(57) ABSTRACT

A laptop computer housing includes a base, a lid, a hinge coupling the base and the lid, and one or more detection circuit for detecting multiple open lid angles between the lid and the base. A method includes detecting an open lid angle between the lid and the base of the laptop, and scaling power consumption of one or more components of the laptop in response to the detected open lid angle. For example, the method may enforce a first reduced power setting for the one or more components in response to detecting a first open lid angle, and may enforce a second reduced power setting for the one or more components in response to detecting a second open lid angle.

### BACKGROUND

Field of the Invention

The present invention relates to a method of power management for a laptop computer.

Background of the Related Art

Mobile computers, such as laptop computers and table computers, are able to continue operating on battery power even when an electrical connection is not available. While the ability to operate on a rechargeable battery makes mobile computers more useful in various applications, the mobile computer can only be used for as long as the battery retains a charge. Accordingly, power saving measures are an important feature of mobile computers.

One way to increase the efficiency of laptop operation is to design and select power-efficient components. This allows the laptop to consume less power during use. However, the battery life may be further extended by implementing an automatic power saving sleep mode responsive to a period of inactivity. For example, the laptop may enter a sleep mode in response to a lack of keyboard or cursor control use for a predetermined period of time. In sleep mode, most of the components of a laptop are turned off while the random access memory is constantly refreshed to maintain the machine state so that the laptop can resume operations in response to a wake-up event. Furthermore, a laptop running the WINDOWS® 7 operating system allows a user to select whether the laptop will shut down, do nothing, or hibernate when the lid is closed.

### BRIEF SUMMARY

One embodiment of the present invention a method, comprising detecting an open lid angle between a lid and a base of a laptop, and scaling power consumption of one or more components of the laptop in response to the detected open lid angle.

Another embodiment of the present invention provides a computer program product comprising a non-transitory computer readable storage medium having program instructions embodied therewith, the program instructions executable by a processor to cause the processor to perform a method comprising detecting an open lid angle between a lid and a base of a laptop, and scaling power consumption of one or more components of the laptop in response to the detected open lid angle.

Yet another embodiment of the present invention provides an apparatus, comprising a laptop computer housing including a base, a lid, and a hinge coupling the base and the lid, and one or more detection circuit for detecting multiple open lid angles between the lid and the base.

### BRIEF DESCRIPTION OF THE SEVERAL VIEWS OF THE DRAWINGS

FIG. 1 is a perspective view of a laptop computer.

FIG. 2 is a schematic side view of the laptop computer illustrating the positioning of various types of lid angle sensors.

FIG. 3 is a schematic diagram of the laptop illustrating various lid angles.

FIG. 4 is a power savings table for entering user settings according to one embodiment of the present invention.

FIG. 5 is a diagram of a compute node or server that is capable of implementing methods of the present invention.

FIG. 6 is a flowchart of a method according to one embodiment of the present invention.

### DETAILED DESCRIPTION

One embodiment of the present invention a method, comprising detecting an open lid angle between a lid and a base of a laptop, and scaling power consumption of one or more components of the laptop in response to the detected open lid angle. Optionally, the open lid angle between the lid and the base may be detected using a detector selected from, without limitation, an accelerometer, potentiometer, series of magnet-switch pairs, or a series of optical source-detector pairs. The method may optionally further comprise causing the laptop to enter a sleep mode in response to the lid being closed.

In one option, the step of scaling power consumption of one or more components of the laptop in response to the detected open lid angle, may include incrementally reducing power consumption of the one or more components in response to determining that the detected open lid angle has been reduced below a first open lid angle. Furthermore, the step of scaling power consumption of one or more components of the laptop in response to the detected open lid angle, may further include incrementally increasing power consumption of the one or more components in response to determining that the detected open lid angle has been increased above a second open lid angle. Accordingly, the power consumption or maximum power consumption setting of the one or more components may be, for example, incrementally reduced as the open lid angle is reduced and incrementally increased as the open lid angle is increased. The first and second open lid angles may be the same or different, for example depending in part upon the nature of a detection circuit used to detect the open lid angle.

In another option, the step of scaling power consumption of one or more components of the laptop in response to the detected open lid angle, may include reducing power consumption of the one or more components in multiple power consumption increments, wherein each power consumption increment is associated with a different open lid angle. Furthermore, the step of scaling power consumption of one or more components of the laptop in response to the detected open lid angle, may further include increasing power consumption of the one or more components in multiple power consumption increments, wherein each power consumption increment is associated with a different open lid angle.

In yet another option, the step of scaling power consumption of one or more components of the laptop in response to the detected open lid angle, includes enforcing a first reduced power setting for the one or more components in response to detecting a first open lid angle. Furthermore, the step of scaling power consumption of one or more components of the laptop in response to the detected open lid angle, may further include enforcing a second reduced power setting for the one or more components in response to detecting a second open lid angle. Optionally, the method may further comprise receiving user input identifying the first and second reduced power settings and the first and second open lid angles. Such user input may be received using a graphical user interface to a power settings screen that is part of the operating system, component drivers, or a system management interface to a service processor. In a further option, the method may further comprise enforcing a third power setting for the one or more components in response to detecting that the lid is closed. When the lid is closed, the lid is parallel to the base and there is no longer an open lid angle between the lid and the base. In certain specific implementations, the first open lid angle may be less than 90 degrees and the second open lid angle may be less than the first open lid angle.

As stated above, the open lid angle between the lid and the base may be detected using a detector selected from, without limitation, an accelerometer, potentiometer, series of magnet-switch pairs, or a series of optical source-detector pairs. In one example, the open lid angle between the lid and the base may be detected using a plurality of magnet/switch pairs that are activated by proximity, wherein the open lid angle is determined according to which one or more of the magnet/switch pairs are activated.

In a specific implementation of the foregoing methods, the laptop may include a central processing unit and a display screen, wherein each of the first and second reduced power settings identify a reduced power level for the central processing unit and a reduced power level for the display screen. For example, the reduced power level for the central processing unit may be identified as an amount of throttling. In a further example, the reduced power level for the display screen may be identified as an amount of brightness or an amount of dimming. In a similar implementation of the foregoing methods, the laptop may include a wireless transceiver, wherein each of the first and second reduced power settings further identifies a reduced power level for the wireless transceiver. Examples of such a wireless transceiver include any wireless local area network (WLAN) device (such as a Wi-Fi™ certified device) and any wireless personal area network (WPAN) device (such as Bluetooth™ device).

Another embodiment of the present invention provides a computer program product comprising a non-transitory computer readable storage medium having program instructions embodied therewith, the program instructions executable by a processor to cause the processor to perform a method comprising detecting an open lid angle between a lid and a base of a laptop, and scaling power consumption of one or more components of the laptop in response to the detected open lid angle.

The foregoing computer program products may further include computer readable program code for implementing or initiating any one or more aspects of the methods described herein. Accordingly, a separate description of the methods will not be duplicated in the context of a computer program product.

Yet another embodiment of the present invention provides an apparatus, comprising a laptop computer housing including a base, a lid, and a hinge coupling the base and the lid, and one or more detection circuit for detecting multiple open lid angles between the lid and the base. For example, the one or more detection circuit may be selected from an accelerometer, potentiometer, a series of optical source-detector pairs, and a series of magnet-switch pairs disposed along opposing edges of the base and lid. Advantageously, a potentiometer may produce a signal indicating a continuous range of open lid angles, as well as indicating when the lid is closed. A series of magnet-switch pairs that are activated upon a given proximity will produce discrete signal in response to the lid reaching a given open lid angle.

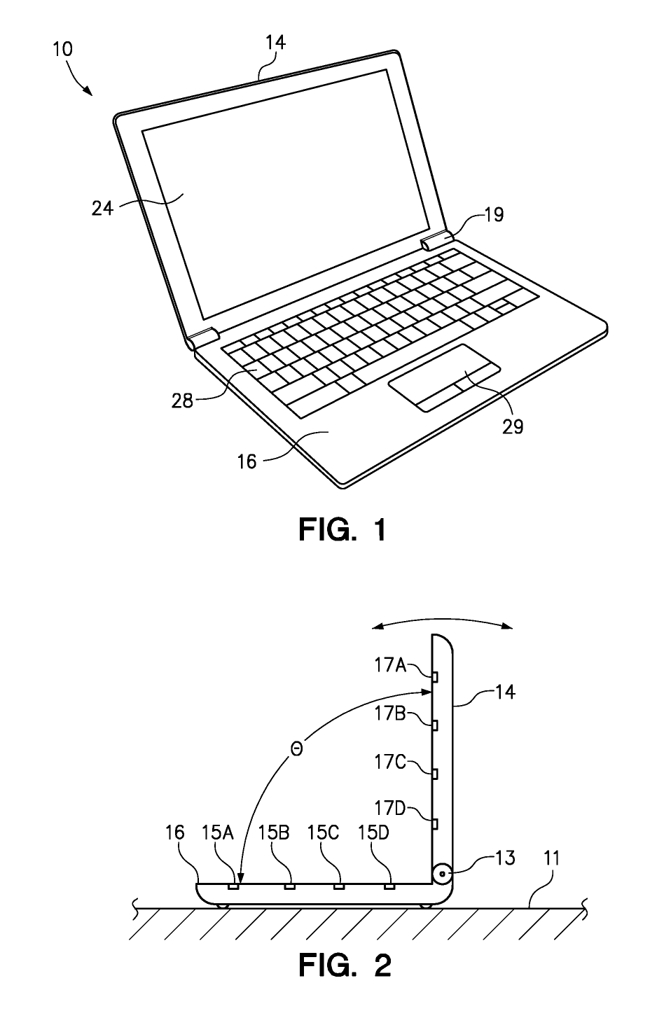

FIG. 1 is a perspective view of a laptop computer 10. The laptop 10 includes a base portion 16 and a lid portion 14 connected to the base portion 16 by a hinge 19. The base portion 16 includes most of the components of the laptop, such as a processor, memory, data storage and wireless network adapter (components not shown). However, the base portion 16 is shown including a keyboard 28 and a cursor control unit 29, such as a mouse or a trackpad. The lid portion 14 is shown including a display screen 24. An angle between the base portion 16 and the lid portion 14 may be adjusted by pushing or pulling the lid 14, relative to the base portion 16, with sufficient force to overcome friction in the hinge 19.

FIG. 2 is a schematic side view of the laptop computer 10 illustrating the positioning of various types of lid angle detectors. In one embodiment, the angle between the lid 14 and the base 16 may be detected or measured by a potentiometer 13, perhaps disposed in axial alignment with the hinge (see hinge 19 in FIG. 1). Accordingly, as the open lid angle changes, a first portion of the hinge 19 that is integral with the lid 14 rotates relative to a second portion of the hinge 19 that is integral with the base 16. The potentiometer 13 may have a first element coupled to the first portion of the hinge and a second element coupled to the second portion of the hinge, such that rotation of the hinge 19 causes rotation between the first and second elements of the potentiometer 13 and an output signal that varies as a function of the angle of rotation.

In an alternative embodiment, the angle between the lid 14 and the base 16 may be detected or measured by a series of magnet/switch pairs. For example, the base 16 may include a series of spaced apart switches 15A-D along one edge of the base, and the lid 14 may include a series of spaced apart magnets 17A-D. In order to detect an angle, the switch in a pair will activate and generate a signal in response to the corresponding magnet being positioned within a given proximity of the switch. Accordingly, if the lid 14 is moved gradually from an angle (θ) of about 90 degrees (as shown) to a closed position, the switch/magnet pair 15D, 17D will activate first as the switch and magnet approach each other, say two inches apart. If the lid 14 is closed further, the switch/magnet pair 15C, 17C will activate next, followed by the switch/magnet pair 15B, 17B and switch/magnet pair 15A, 17A. If the lid 14 is not fully closed, only one or more switch/magnet pairs may be activated, such that the angle between the lid and base are determined.

FIG. 3 is a schematic diagram of the laptop 10 illustrating various lid angles. In particular, the diagram illustrates the lid 14 at open lid angles of 120°, 90°, 70°, 40° and 10° and in a closed position where the lid is at an angle of 0°. In this diagram, the potentiometer 13 detects each of the angle between the lid 14 and the base 16 and can generate a signal that identifies that angle.

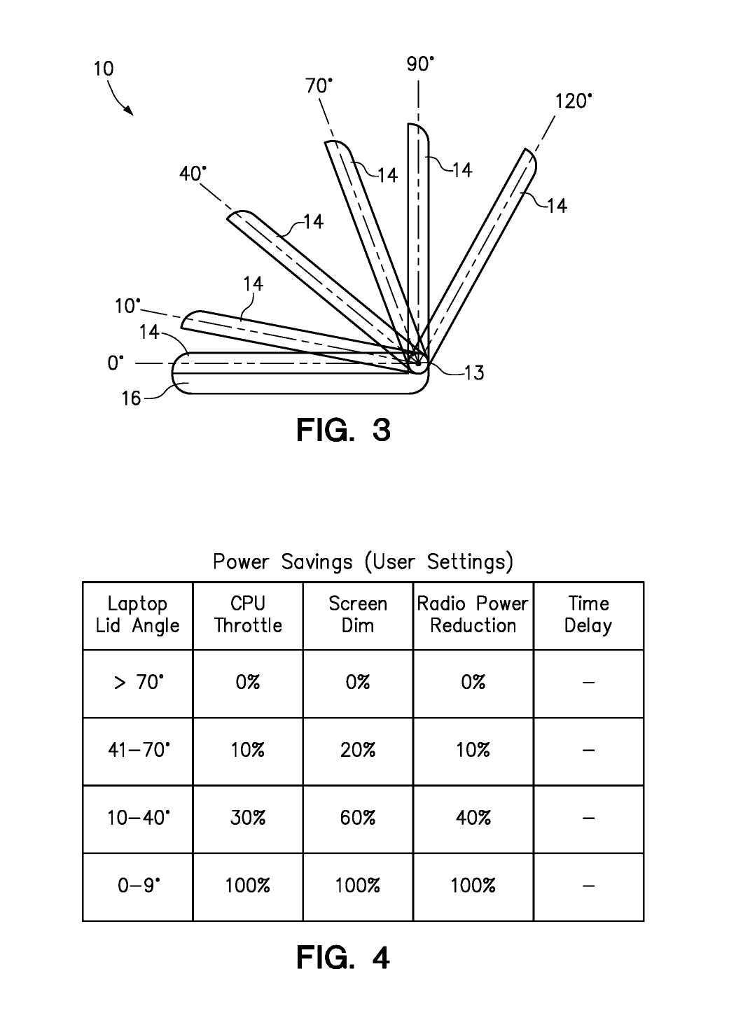

FIG. 4 is a power savings table for entering user settings according to one embodiment of the present invention. The power savings table may be stored by an operating system (i.e., control panel), one or more drivers, or in system management firmware executed by a service processor, such as a baseboard management controller. In this example, the power savings table includes columns for “laptop lid angle”, “CPU Throttle”, “Screen Dim”, “Radio Power Reduction” and “Time Delay”. Each row of the table is a power settings record. For example, the first record indicates that at an open lid angle greater than 70°, the CPU is not throttled, the screen is not dimmed, and the radio power is not reduced. A second record indicates that at an open lid angle between 41 and 70°, the CPU is throttled 10% (i.e., may run at 90% full performance), the screen is dimmed 20% (i.e., may run at 80% full performance), and the radio power is reduced 10% (i.e., may run at 90% full performance). A third record indicates that at an open lid angle between 10 and 40°, the CPU is throttled 30% (i.e., may run at 70% full performance), the screen is dimmed 60% (i.e., may run at 40% full performance), and the radio power is reduced 40% (i.e., may run at 60% full performance). A fourth record indicates that an angle from 0-9 should be treated the same as if the lid is “closed”, such that the CPU, screen and radio are all shut off. Using the table, a user may customize the number of power setting records and the values specified for each power setting record. While none of the records shown include a time delay, it is possible to require a time delay in each power setting record.

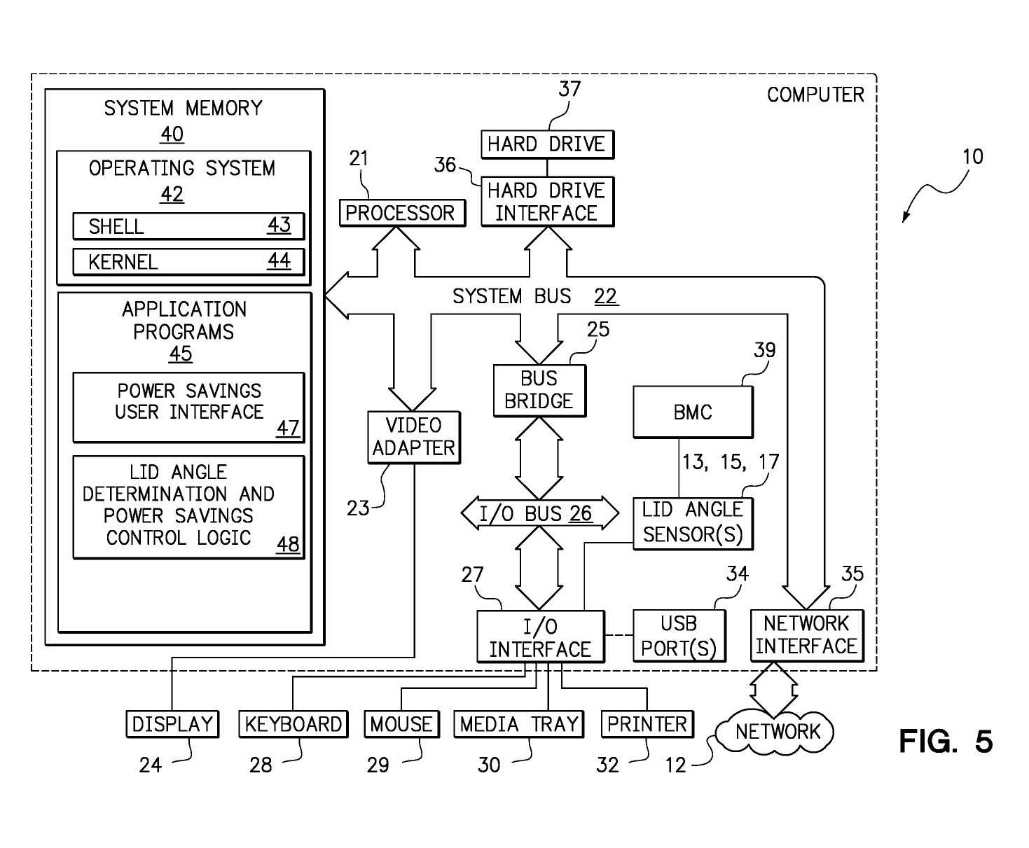

FIG. 5 is a diagram of the laptop computer 10 capable of implementing methods of the present invention. In this non-limiting example, the compute node 10 includes a processor unit 21 that is coupled to a system bus 22. The processor unit 21 may utilize one or more processors, each of which has one or more processor cores. A video adapter 23, which drives/supports a display 24, is also coupled to the system bus 22. The system bus 22 is coupled via a bus bridge 25 to an input/output (I/O) bus 26. An I/O interface 27 is coupled to the I/O bus 26 and provides communication with various I/O devices, including a keyboard 28, a mouse 29, a media tray 30 (which may include storage devices such as CD-ROM drives, multi-media interfaces, etc.), a printer 32, and USB port(s) 34. As shown, the compute node 10 is able to communicate with other network devices via the network 12 using a network adapter or network interface controller 35. Furthermore, the lid angle sensors 13, 15, 17 (shown in FIG. 2) may also be connected to the I/O interface 27 and/or to a baseboard management controller 39.

A hard drive interface 36 is also coupled to the system bus 22 and interfaces with a hard disk drive 37. In a preferred embodiment, the hard disk drive 37 communicates with system memory 40, which is also coupled to the system bus 22. System memory includes the lowest level of volatile memory in the compute node 20. This volatile memory may include additional higher levels of volatile memory (not shown), including, but not limited to, cache memory, registers and buffers. Data that populates the system memory 40 may include an operating system (OS) 42 and application programs 45.

The operating system 42 includes a shell 43 for providing transparent user access to resources such as application programs 45. Generally, the shell 43 is a program that provides an interpreter and an interface between the user and the operating system. More specifically, the shell 43 executes commands that are entered into a command line user interface or from a file. Thus, the shell 43, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 44) for processing. Note that while the shell 43 is a text-based, line-oriented user interface, the present invention will equally well support other user interface modes, such as graphical, voice, gestural, etc.

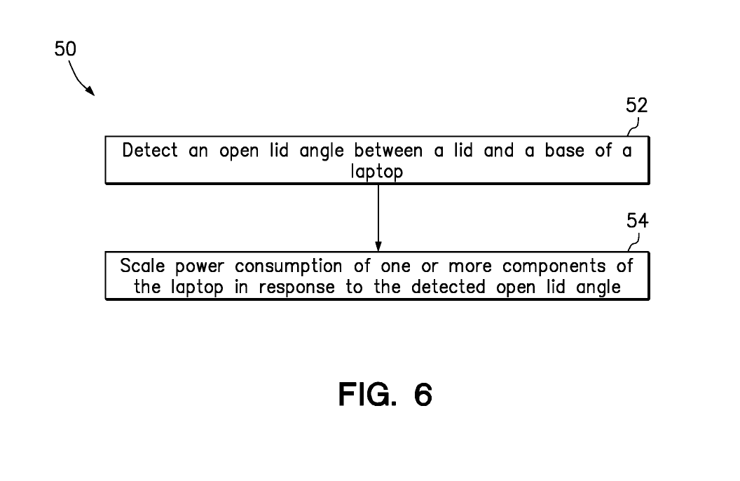

As depicted, the operating system 42 also includes the kernel 44, which includes lower levels of functionality for the operating system 42, including providing essential services required by other parts of the operating system 42 and application programs 45, including memory management, process and task management, disk management, and mouse and keyboard management. The application programs 45 in the system memory of the compute node 20 may include, without limitation, power savings user interface 47, according to one embodiment such as that shown in FIG. 4, and lid angle determination and power savings control logic 48, according to an embodiment such as that shown below in FIG. 6. Optionally, all or part of these applications may be included as part of the operating system 42 or executed by the baseboard management controller 39.

The hardware elements depicted in the compute node 10 are not intended to be exhaustive, but rather are representative. For instance, the compute node 10 may include alternate memory storage devices such as magnetic cassettes, digital versatile disks (DVDs), Bernoulli cartridges, and the like. These and other variations are intended to be within the scope of the present invention.

FIG. 6 is a flowchart of a method 50 according to one embodiment of the present invention. In step 52, the method detects an open lid angle between a lid and a base of a laptop. An “open lid angle” is an angle between the lid and base in which the lid is not “closed”. In step 54, the method scales power consumption of one or more components of the laptop in response to the detected open lid angle.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention may be described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, comprising:
detecting an open lid angle between a lid and a base of a laptop; and
scaling power consumption of one or more components of the laptop in response to the detected open lid angle.

2. The method of claim 1, wherein scaling power consumption of one or more components of the laptop in response to the detected open lid angle, includes incrementally reducing power consumption of the one or more components in response to determining that the detected open lid angle has been reduced below a first open lid angle.

3. The method of claim 2, wherein scaling power consumption of one or more components of the laptop in response to the detected open lid angle, includes incrementally increasing power consumption of the one or more components in response to determining that the detected open lid angle has been increased above a second open lid angle.

4. The method of claim 1, wherein scaling power consumption of one or more components of the laptop in response to the detected open lid angle, includes reducing power consumption of the one or more components in multiple power consumption increments, wherein each power consumption increment is associated with a different open lid angle.

5. The method of claim 1, wherein scaling power consumption of one or more components of the laptop in response to the detected open lid angle, includes increasing power consumption of the one or more components in multiple power consumption increments, wherein each power consumption increment is associated with a different open lid angle.

6. The method of claim 1, wherein scaling power consumption of one or more components of the laptop in response to the detected open lid angle, includes enforcing a first reduced power setting for the one or more components in response to detecting a first open lid angle.

7. The method of claim 6, wherein scaling power consumption of one or more components of the laptop in response to the detected open lid angle, includes enforcing a second reduced power setting for the one or more components in response to detecting a second open lid angle.

8. The method of claim 7, further comprising:
receiving user input identifying the first and second reduced power settings and the first and second open lid angles.

9. The method of claim 7, further comprising:
enforcing a third power setting for the one or more components in response to detecting that the lid is closed.

10. The method of claim 7, wherein the first open lid angle is less than 90 degrees and the second open lid angle is less than the first open lid angle.

11. The method of claim 1, further comprising:
causing the laptop to enter a sleep mode in response to the lid being closed.

12. The method of claim 1, wherein the open lid angle between the lid and the base is detected using an accelerometer, potentiometer, series of magnets (multiple pairs of magnets and switches), aligning visual indicators with cameras, etc.

13. The method of claim 1, wherein the open lid angle between the lid and the base is detected using a plurality of magnet/switch pairs that are activated by proximity, wherein the open lid angle is determined according to which one or more of the magnet/switch pairs are activated.

14. The method of claim 7, wherein the laptop includes a central processing unit and a display screen, and wherein each of the first and second reduced power settings identify a reduced power level for the central processing unit and a reduced power level for the display screen.

15. The method of claim 14, wherein the reduced power level for the central processing unit is identified as an amount of throttling.

16. The method of claim 14, wherein the reduced power level for the display screen is identified as an amount of brightness.

17. The method of claim 14, wherein the laptop includes a wireless transceiver, and wherein each of the first and second reduced power settings further identifies a reduced power level for the wireless transceiver.

18. A computer program product comprising a non-transitory computer readable storage medium having program instructions embodied therewith, the program instructions executable by a processor to cause the processor to perform a method comprising:
detecting an open lid angle between a lid and a base of a laptop; and
scaling power consumption of one or more components of the laptop in response to the detected open lid angle.

19. An apparatus, comprising:
a laptop computer housing including a base, a lid, and a hinge coupling the base and the lid;
one or more detection circuit for detecting multiple open lid angles between the lid and the base.

20. The apparatus of claim 19, wherein the one or more detection circuit is selected from a potentiometer and a series of magnet-switch pairs disposed along opposing edges of the base and lid.
